(19) United States
(12) Patent Application Publication
(10) Pub. No.: US 2011/0226200 A1
(43) Pub. Date: Sep. 22, 2011

(54) AXIAL FLOAT PLATE

(76) Inventor: John M. Trease, Melbourne (AU)

(21) Appl. No.: 13/053,575

(22) Filed: Mar. 22, 2011

Related U.S. Application Data
(60) Provisional application No. 61/282,710, filed on Mar. 22, 2010.

(51) Int. Cl. F02B 75/22

(52) U.S. Cl. 123/54.4

(57) ABSTRACT

A camshaft drive mechanism used in V-twin engines provided with dual camshafts. An axial float plate is provided to control the longitudinal movement of the camshafts. This plate is provided on flanges of the camshafts, thereby eliminating the thrust washers used in prior art V-twin engines.

### CROSS-REFERENCE TO RELATED APPLICATIONS

The present invention claims the benefit of the filing date of U.S. Provisional Patent Application Ser. No. 61/282,710, entitled “Cam Shaft Drive Mechanism With Axial Float Plate”, filed Mar. 22, 2010 and incorporates all of the material included therein by reference.

### FIELD OF THE INVENTION

This invention relates to internal combustion engines of the type comprising twin cylinders arranged in a V in a plane normal to the crankshaft. More particularly, the invention relates to the camshaft included in such engines, which camshaft actuates the valves that control the flow of air/fuel mixture into, and exhaust gas out of, the cylinders.

### BACKGROUND OF THE INVENTION

A common type of motorcycle engine is the so-called “V-twin” engine in which the two cylinders are arranged in a V with the cylinders lying on a plane which is transverse to the crankshaft and normal thereto. The axes of the cylinders meet at the axis of the crankshaft. These types of engines also include a camshaft typically provided in the crankcase. The camshaft is driven by a pinion gear on the crankshaft. The camshaft, via pushrods and rocker arms, actuates valves which control the influx of air/fuel mixture from the carburetor as well as the efflux of the combusted mixture. V-twin engines are also known to have twin camshafts. These engines generally exhibit superior performance over an otherwise identical engine due to the improved pushrod geometry providing better operation of the valves. Typically the twin camshafts are driven by a chain drive running from a gear on the crankshaft. The chain drive of the twin camshafts of engines of the foregoing type is unsatisfactory because of a limited service life, due to the chain drive requiring adjustment or even replacement. Furthermore, chain breakage can occur with damage to the engine and, in some instances, injury to the rider of a motorcycle powered by the engine. It was therefore desirable to have available an internal combustion engine of the V-twin configuration with dual camshafts, wherein the camshaft drive mechanism was positively driven and did not employ a chain drive, with its attendant operational limitations.

U.S. Pat. No. 6,543,401, granted Apr. 8, 2003, to John M. Trease, discloses a camshaft drive mechanism for an internal combustion engine of the “V-twin” configuration which does not use a chain drive. This patent provides a camshaft drive mechanism for an internal combustion engine of the type comprising twin cylinders arranged in a V provided in a plane normal to the axis of the crankshaft of the engine. The camshaft mechanism comprises a first camshaft for actuating inlet and exhaust valves of one of the cylinders, and a second camshaft for actuating inlet and exhaust valves of the other cylinder, the camshafts rotating on axes parallel to the axis of the crankshaft. The camshafts are driven by a gear on the crankshaft engaging a primary gear on the first camshaft with an adjacent secondary gear on the first camshaft imparting counter-rotation on the second camshaft via an identical secondary gear on said second camshaft, as shown in FIGS. 2-4 of the '401 patent.

The '401 patent replaced the chain drive of art twin camshaft V-twin engines with a gear drive, and disadvantages associated with a chain driven cam engine were overcome. Furthermore, the '401 patent found that the long-term performance of an engine including the camshaft drive mechanism of the invention did not deteriorate, in contrast to the diminished performance of an engine with chain-driven camshafts. Additionally, the rigid drive train of the camshaft drive mechanism reduced vibrations.

However, the gear drive utilized in the '401 patent as well as other gear driven mechanisms used with twin camshafts endeavored to minimize the space occupied by the primary and secondary gears, while maintaining lateral alignment of the gears while preventing longitudinal movement of the camshafts. This was accomplished by the utilization of thrust washers positioned against the back wall of a cam chest as well as around the end of one of the camshafts and a cam chest cover. A final thrust washer is provided in the cam chest cover. These close tolerances would make it difficult to properly align a crankshaft main center bearing with a cam bearing.

### SUMMARY OF THE INVENTION

The problems of the existing art are addressed by the present invention which employs an axial float plate around the camshaft between the camshaft and the cam chest cover. The use of the axial float plate would eliminate the need of any of the thrust washers used in the previously described engines.

### BRIEF DESCRIPTION OF THE DRAWINGS

Various embodiments of the invention will be described with reference to the following drawings, in which:

FIG. 1 is a perspective view of a crankcase for use with the camshaft drive mechanism of the invention;

FIG. 2 is an end view of the crankcase shown in FIG. 1 with the drive mechanism in situ;

FIG. 3 is a cross-section of FIG. 1;

FIGS. 4A and 4B are plan views of portions of camshafts with gears of the drive mechanism, incorporating an axial float setting plate;

FIG. 5 is a perspective view of the cam chest cover;

FIG. 6 is a front view of the axial float setting plate; and

FIG. 7 is a view of the relationship between the axial float setting plate and the camshaft.

### DETAILED DESCRIPTION OF THE INVENTION

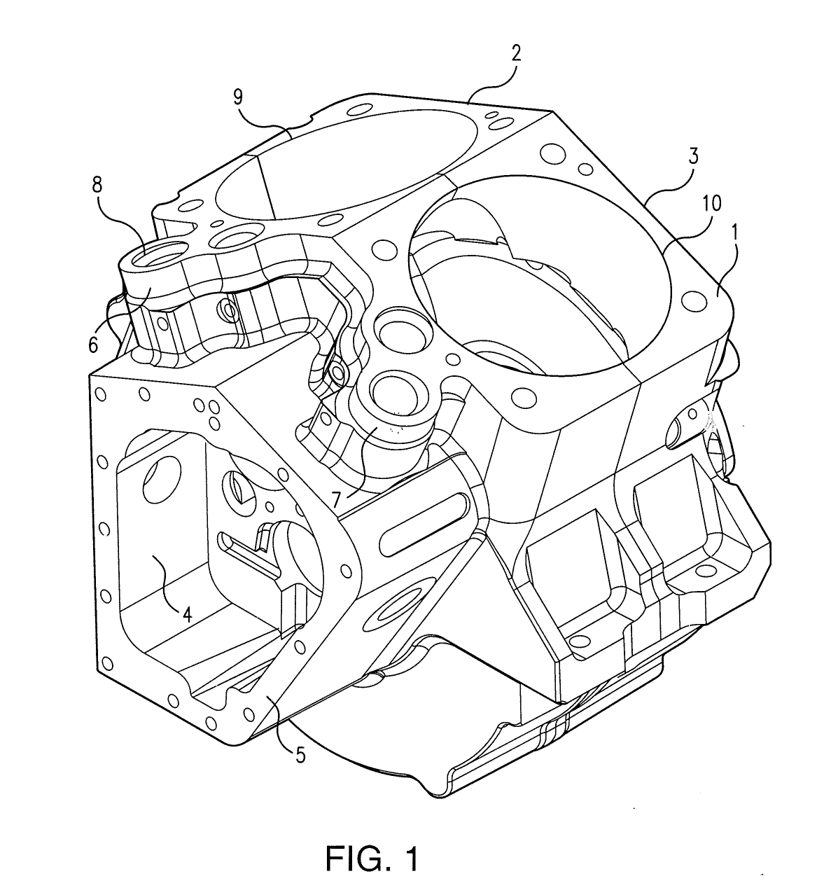

In the following detailed description, the same reference number will be used to identify a feature visible in more than one figure. FIG. 1 shows crankcase 1 having faces 2 and 3 for mounting cylinders thereon, with the axes of the cylinders at approximately 45°. Each face is provided with a single cylinder, each cylinder including inlet and outlet valves. The crankcase further has a cam chest 4 at one end thereof in which an assembled engine has a cover (not shown) which abuts face 5 of the cam chest. Crankcase 1 also includes tappet blocks 6 and 7, each of which houses a cam-follower.

In an assembled engine, pushrods extend from the cam-followers through apertures in the tappet blocks to the rocker arms. One such aperture is indicated at 8. The connecting rods (not shown) extend through apertures 9 and 10 in the crankcase 1 to interconnect the pistons and the crankshaft.

Crankcase 1 can be constructed from an aluminum casting which is machined, as necessary, to provide surfaces for abutment of other engine components and tapped holes for securing components to the crankcase. Tappet blocks 6 and 7 are similarly machined to provide cylinders for the cam-followers (not shown in the drawing).

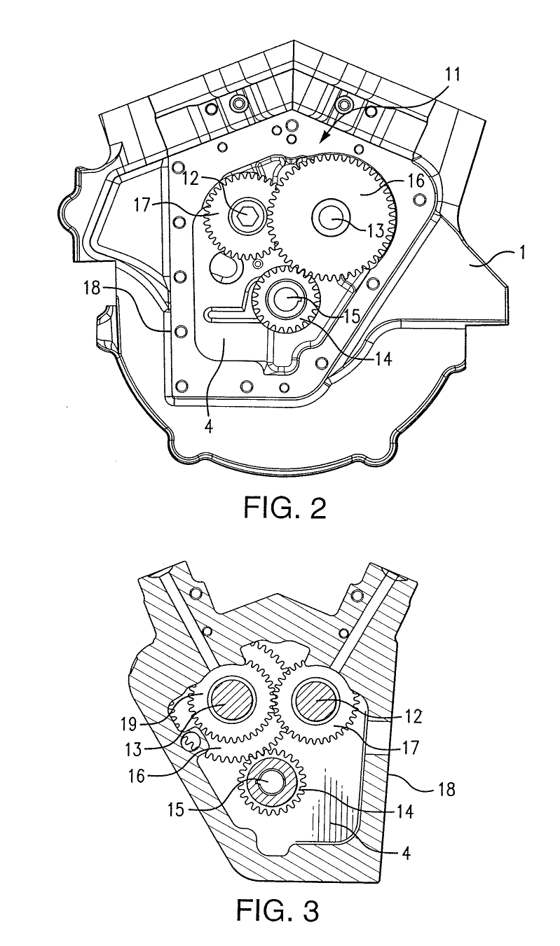

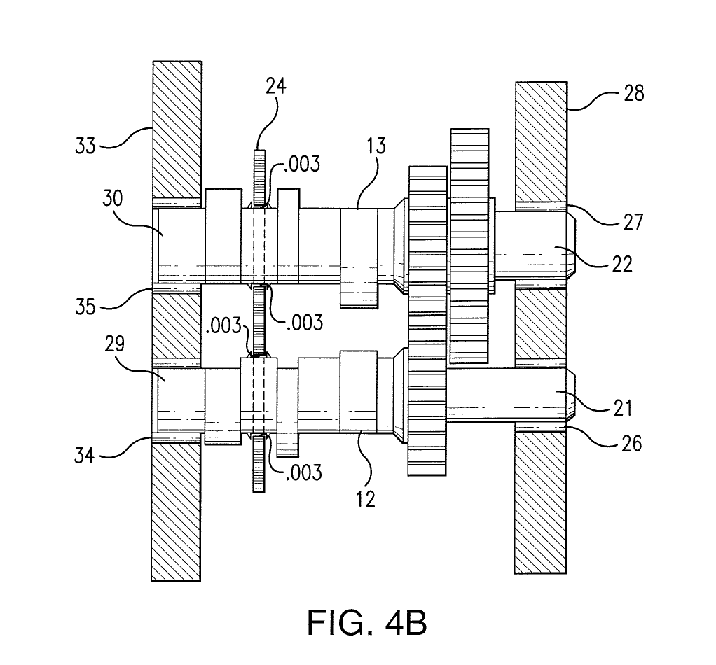

FIG. 2 shows the crankcase 1 with a camshaft drive mechanism 11 in situ. The camshaft drive mechanism 11 comprises camshafts 12 and 13, a drive gear 14 at an end of a crankshaft 15, a primary (idler) gear 16, and secondary gears on the camshafts, one of which secondary gears can be seen as item 17. The drive mechanism 11 is housed in the cam chest or nose cone support plate 4 which is also defined by side wall 18. Camshafts 12 and 13 are located in needle bearings 34 and 35, respectively, in a back wall 33 (see FIGS. 4A and 4B) of the cam chest 4, and in needle bearings 26 and 27, respectively, in the cam chest cover 28 (see FIGS. 4A and 4B) over the cam chest in an assembled engine. Crankshaft 15 is carried by the conventional bearings used in other engines of this type. The movement of each of the camshafts 12, 13 opens and closes, in a timed relation, the inlet valve and outlet valve in its respective cylinder.

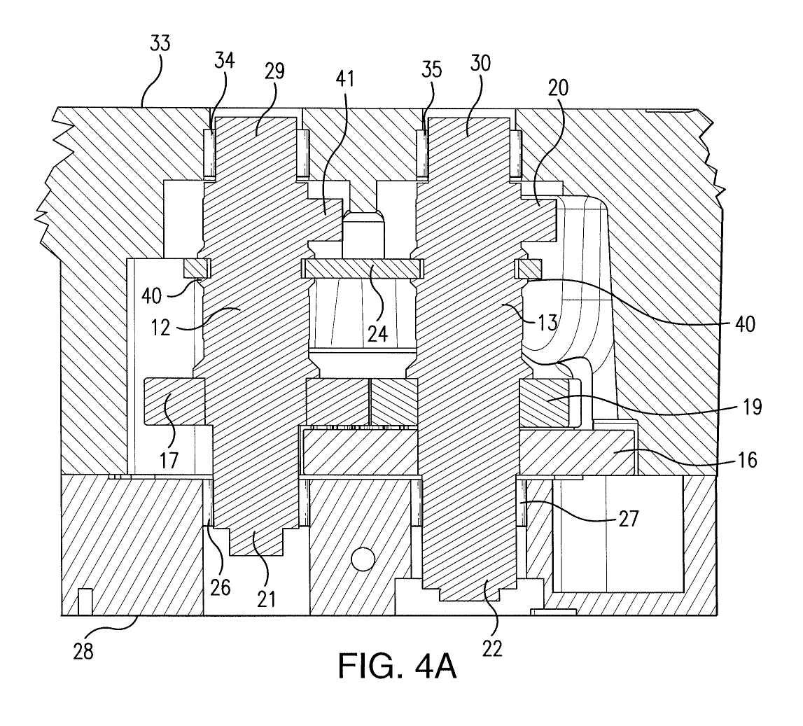

FIG. 3 is a reverse view of the drive mechanism 11 as shown in FIG. 2. FIG. 3 illustrates the cam chest wall 18 as well as (in cross-section) camshafts 12 and 13 and crankshaft 15. Also visible are the drive gear 14, primary gear 16 and both secondary gears 17 and 19.

The disposition of the primary gear 16 and secondary gears 17 and 19 can be appreciated from FIG. 4A. This figure shows camshafts 12 and 13 with primary gear 16 and secondary gear 19 provided on camshaft 13, and secondary gear 17 included on camshaft 12. A lobe 20 of a cam on camshaft 13 is also shown in FIG. 4A. A similar lobe 41 of camshaft 12 is also shown in the figure. Ends 21 and 22 of camshafts 12 and 13 are received in needle bearings 26 and 27, respectively, in cam chest cover 28. Ends 29 and 30 of camshafts 12 and 13 are received in needle bearings 34 and 35 of the back wall 33 of the cam chest.

Rotation of the crankshaft 15 causes the rotation of the drive gear 14. The drive gear 14 engages the primary gear 16 provided on the camshaft 13. The primary gear 16 engages the secondary gear 19 also provided on camshaft 13. The secondary gear 19 engages secondary gear 17 provided on camshaft 12, imparting a counter-rotation of the camshaft 12 with respect to camshaft 13.

To control longitudinal movement of camshafts 12 and 13, and thus maintain correct alignment of gears 14, 16, 17 and 19, an axial float setting plate 24 is provided. The axial float setting plate is mounted via screws into cam chest 4. Its position is located via two ¼″ dowel pins. The exact number of screws as well as dowel pins is not crucial. However, it has been found that using three screws and two dowel pins has proved to be effective. The axial float setting plate's profile is shaped such that it gives ample lateral clearance of camshafts 12 and 13, but maintains an accurate axial position and clearances of ±0.007″ between the axial float setting plate 24 and the notches 40 of the camshafts 12 and 13 in which the camshafts locate. The accuracy of the axial float is important to maintain the integrity and life span of all neighboring and connected parts and to prevent seizure. An additional benefit of the axial float plate 24 is that assembly of the camshafts is made easier by virtue of the shape of the plate.

The axial float plate 24 is provided with a notch and an edge on either side which fits within a groove between each of the notches 40 of each of the camshafts 12 and 13, allowing at least one or both of the camshafts 12 and 13 to float within the notches of the axial float plate 24. This configuration would allow one or both of the camshafts to maintain the proper tolerances and clearances with respect to the primary gear 16 and the secondary gears 17 and 19.

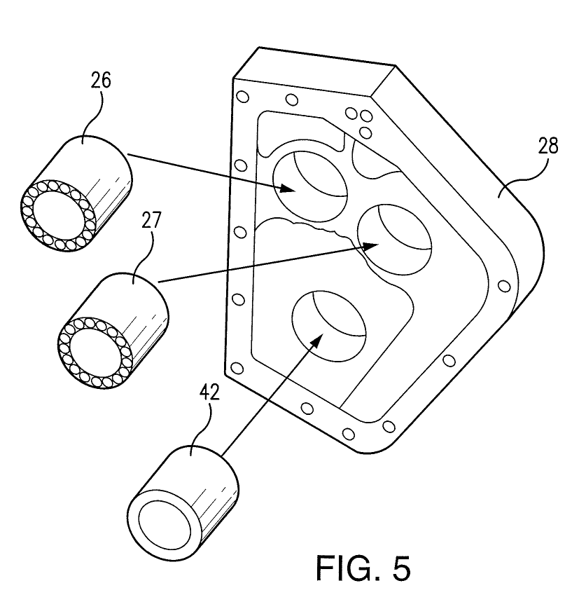

FIG. 5 shows the cam chest cover 28. As previously described, ends 21 and 22 of the camshafts 12 and 13 are received in needle bearings 26 and 27, respectively. As shown in FIGS. 4A and 4B, the other ends 29 and 30 of camshafts 12 and 13 are received in needle bearings 34 and 35 of the back wall 33 of the cam chest. FIG. 5 also shows the inclusion of a brass bushing 42 which supports a pinion shaft (not shown) of the engine.

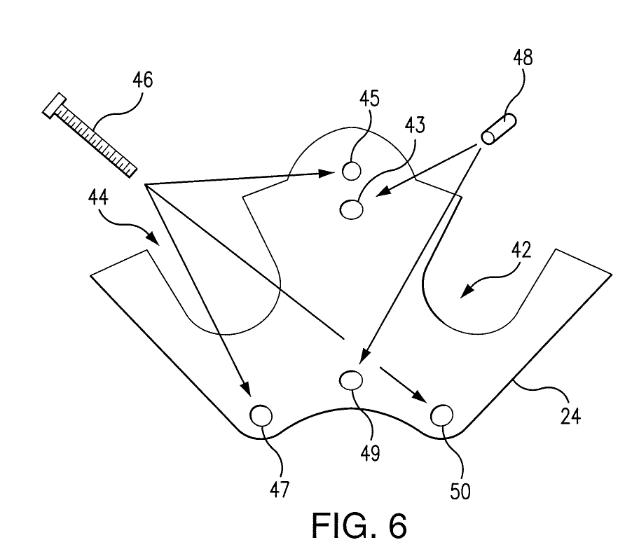

FIG. 6 shows a front view of the axial float setting plate 24. The position of this plate 24 is shown in more detail in FIGS. 4A and 4B. The plate has two notches 42, 44 into which one of the camshafts 12 and 13 is provided. However, it is important to note that each of the camshafts 12 and 13 would float between its respective notches 42 or 44 and does not support the camshaft in any manner. Since the thrust washers of the prior art design are not included in the present invention, this configuration sets the end play for the camshafts 12 and 13 to move in two lateral directions. As shown in FIG. 6, holes 45, 47 and 50 provided in the axial float setting plate 24 are used to affix three bolts 46 to the cam chest 4. Dowel pins 48 are inserted through holes 43 and 49 provided in the axial float setting plate 24 to properly position the plate 24 in place.

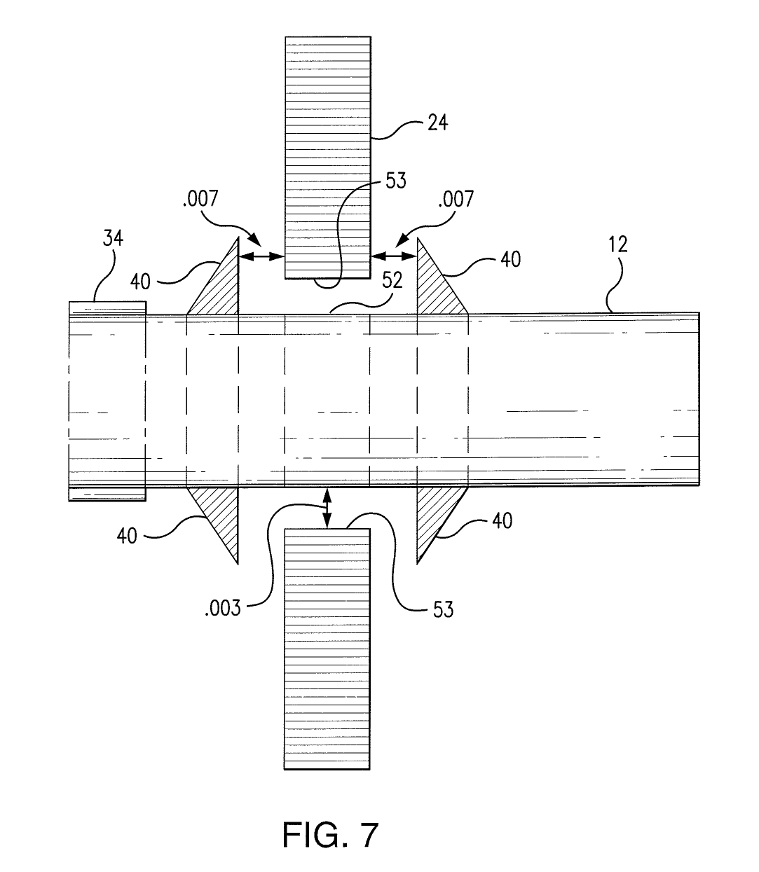

FIG. 7 shows the position of the axial float setting plate 24 with respect to camshaft 12 in more detail than as shown in FIG. 4A. Although FIG. 4A shows the cam notches 40 which appear to abut the sides of the axial float setting plate 24, this is not the case. The design of the present invention is better illustrated in FIG. 7 which shows a distance of 0.007 inches between each side of the axial float setting plate 24 and the notches 40. In operation, the camshaft 12, as well as the camshaft 13 would float between the sides of the plate 24 and the cam notches 40. Additionally, as shown in FIG. 7, the end surfaces 53 of the axial float setting plate does not touch the surface 52 of the camshaft 12. A similar configuration is provided between the axial float setting plate 24 and the camshaft 13. As shown in FIG. 7, a distance of approximately 0.003 inches is maintained between the ends 53 of the plate 24 and the surface 52 of camshaft 12. Additionally, it is noted that the axial float setting plate 24 has a thickness of 0.25 inches.

In the exemplified crankcase, the axes of camshafts 12 and 13 are 2.1875″ apart while the axis of crankshaft 15 is 2.5312″ from the axis of camshaft 13. All gears have a pitch of 16 DP with the following number of teeth per gear:
Drive gear 14—27 teeth
Primary gear 16—54 teeth
Secondary gears 17 and 19—35 teeth each

The drive, primary and secondary gears are manufactured from any material suitable for high-stress camshaft applications. These gears are either pressed on to camshafts as friction fits, or machined from a casting of an integral shaft and gear(s).

To test the efficiency of the camshaft drive mechanism described above, a V-twin engine of 113 in³ was prepared from after-sale components save that the twin camshafts were driven by the described mechanism. The performance of this engine was compared with a stock Harley Davidson 88 in³ engine.

The horsepower and torque of the engine including the camshaft drive mechanism as illustrated were found to be essentially unchanged after about 12 months' use. By comparison, the horsepower and torque of the Harley Davidson engine were found to have decreased by 5-7% over the same period. These decreases were considered to be due to deterioration of the chain driving the camshafts. This determination is obviated by applicant's camshaft drive mechanism wherein its precision alignment is enhanced by the axial float plate.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. An internal combustion engine provided with a crankcase having a back wall and a crankshaft, the crankcase including twin cylinders arranged in a V-shape in a plane normal to the axis of the crankcase, each of the cylinders provided with inlet and outlet valves and a cam chest having a cover separated from the crankcase by a divider wall, comprising:
a first camshaft provided between the back wall and the cam chest cover actuating the inlet valve and the outlet valve of one of the cylinders, said first camshaft provided with a first flange having a first groove;
a second camshaft provided between the back wall and the cam chest cover actuating the inlet valve and the outlet valve of the second cylinder, said second camshaft provided with a second flange having a second groove;
a gear train housed in the cam chest including a drive gear provided on the crankshaft for driving said first and second camshafts, said gear train additionally including a primary gear and first and second secondary gears, said primary gear and said first secondary gear provided on said first camshaft and said second secondary gear provided on said second camshaft, said drive gear engaging said primary gear, said primary gear engaging said first secondary gear engaging said second secondary gear;
an axial float setting plate having a pair of notches secured to a divider wall in the cam chest, one of said notches nesting in said first groove of said first camshaft and said second notch nesting in said second groove of said second camshaft, said axial float setting plate controlling the longitudinal movement of said first and second camshafts constantly maintaining a first gap between said first and second flanges and said axial float setting plate.

2. The internal combustion engine in accordance with claim 1, wherein said first gap is ±0.007 inches.

3. The internal combustion engine according to claim 1, wherein said gears of said camshaft drive mechanism have a pitch of 16 DP, and said drive gear has 27 teeth, said primary gear has 54 teeth, and said secondary gears have 35 teeth.

4. The internal combustion engine in accordance with claim 1, wherein said first camshaft and said second camshaft do not support said axial float setting plate.

5. The internal combustion engine in accordance with claim 1, wherein a second gap is provided between said first camshaft and a first end surface of said axial float setting plate and a third gap is provided between said second camshaft and a second end surface of said axial float setting plate.

6. The internal combustion engine in accordance with claim 5, wherein said second and third gaps are 0.003 inches.
